(19) United States
(12) Patent Application Publication
(10) Pub. No.: US 2023/0332078 A1
(43) Pub. Date: Oct. 19, 2023

(54) FOOD PROCESSING APPARATUS AND METHOD FOR OPERATING FOOD PROCESSING APPARATUS

(71) Applicant: Panasonic Intellectual Property Management Co., Ltd., Osaka (JP)

(72) Inventors: KUNIHIRO UKAI, Nara (JP); DAISUKE INO, Nara (JP); YASUHIRO HASHIMOTO, Nara (JP); HIDENOBU WAKITA, Kyoto (JP); SATORU YAMAJI, Osaka (JP)

(21) Appl. No.: 18/333,021

(22) Filed: Jun. 12, 2023

Related U.S. Application Data
(63) Continuation of application No. PCT/JP2021/041250, filed on Nov. 9, 2021.

(30) Foreign Application Priority Data
Dec. 25, 2020 (JP) 2020-216486

(51) Int. Cl. C12C 7/28; B01F 27/90; B01F 27/1125; B01J 19/00; B01F 35/92; B01J 19/12; B01F 27/15; B01F 27/85; B01F 27/93; B01F 101/06; B01F 35/90

(52) U.S. Cl. CPC C12C 7/28; B01F 27/1125; B01F 27/15; B01F 27/85; B01F 27/90; B01F 27/93; B01F 35/92; B01J 19/0006; B01J 19/0066; B01J 19/123; B01F 2035/99; B01F 2101/06; B01J 2219/0801; B01J 2219/0877; B01J 2219/0892; B01J 2219/1203

(57) ABSTRACT

A method for operating a food processing apparatus is provided. The food processing apparatus includes a reaction vessel that has a space that accumulates a liquid reactant used for a food product; a catalytic reactor that includes a reaction tube and a light source; and an introducing tube for introducing the reactant into the reaction vessel. The reaction tube has an outer surface where a photocatalyst is provided. The reaction tube transmits light. The light source generates heat at a time of light emission in which the light source emits light from an inner side of the reaction tube. The method for operating the food processing apparatus includes introducing the reactant into the reaction vessel from the introducing tube. In the introducing, the reactant is introduced up to a position at which a liquid surface of the reactant is positioned higher than an opening portion of the introducing tube.

### BACKGROUND

### 1. Technical Field

The present disclosure relates to a method for operating a food processing apparatus and a food processing apparatus.

### 2. Description of the Related Art

Japanese Unexamined Patent Application Publication No. 2003-250514 discloses a manufacturing method in which a photocatalyst is used in a process of manufacturing a food product to kill microorganisms in a brewed product at normal temperature in an unheated condition.

### SUMMARY

There is, however, room for improvement in the apparatus or the manufacturing method in Japanese Unexamined Patent Application Publication No. 2003-250514 mentioned above. For example, there is a problem in that it is difficult to effectively reform a reactant that is used for a food product.

One aspect of the present disclosure has been made in consideration of such a circumstance, and one non-limiting and exemplary embodiment provides a food processing apparatus capable of effectively reforming a reactant that is used for a food product.

In one general aspect, the techniques disclosed here feature a method for operating a food processing apparatus. The food processing apparatus includes a reaction vessel that has a space that accumulates a liquid reactant used for a food product; a catalytic reactor that includes a reaction tube and a light source; and an introducing tube for introducing the reactant into the reaction vessel. The reaction tube has an outer surface where a photocatalyst is provided. The reaction tube transmits light. The light source generates heat at a time of light emission in which the light source emits light from an inner side of the reaction tube. The method for operating the food processing apparatus includes introducing the reactant into the reaction vessel from the introducing tube. In the introducing, the reactant is introduced up to a position at which a liquid surface of the reactant is positioned higher than an opening portion of the introducing tube.

It should be noted that this comprehensive or specific aspect may be realized by an apparatus, a system, a method, an integrated circuit, a computer program, or a computer-readable recording medium, or may be realized by any combination of an apparatus, a system, a method, an integrated circuit, a computer program, and a computer-readable recording medium. The computer-readable recording medium includes, for example, a nonvolatile recording medium such as a CD-ROM (Compact Disc-Read Only Memory).

According to the present disclosure, the food processing apparatus can be operated stably and a reactant that is used for a food product can be reformed effectively.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates one example of a food processing apparatus according to a first embodiment;

FIG. 2 illustrates one example of a structure of a catalytic reactor according to the first embodiment;

FIG. 3 is a block diagram of the food processing apparatus according to the first embodiment;

FIG. 4 is a flowchart showing one example of a method for operating the food processing apparatus according to the first embodiment;

FIG. 5 illustrates one example of a food processing apparatus according to Modification 1 of the first embodiment;

FIG. 6 illustrates another example of the food processing apparatus according to Modification 1 of the first embodiment;

FIG. 7 illustrates one example of a food processing apparatus according to Modification 2 of the first embodiment;

FIG. 8 is a flowchart of an introduction step according to Modification 3 of the first embodiment;

FIG. 9 illustrates one example of a food processing apparatus according to a second embodiment; and

FIG. 10 is a sectional view along X-X in FIG. 9.

### DETAILED DESCRIPTIONS

### Underlying Knowledge Forming Basis of the Present Disclosure

The inventors have found that the following problems occur in the apparatus or method for manufacturing a food product described in the section of the “Background Art”.

In the manufacture of a food product, reforming of a raw material that is used for the food product is widely performed for the purpose of, for example, improving the manufacturing efficiency and increasing the content of a nutritional component.

As a method for reforming a raw material for a food product, there is a method that uses a catalyst. For example, there is a method for using a nickel catalyst to hydrogenate an oil/fat component, serving as a raw material, in manufacturing margarine. Using an immobilized enzyme in the manufacture of a food product can also be one use of a catalyst.

Although not from the point of view of reforming a raw material for a food product, a catalyst may be used for the purpose of sterilization in a manufacturing process. For example, in Japanese Unexamined Patent Application Publication No. 2003-250514, a manufacturing method in which a photocatalyst is used in a process of manufacturing a food product to kill microorganisms in a brewed product at normal temperature in an unheated condition is examined.

In a conventional method using a catalyst, when a reactant differing from a reactant assumed when reforming a raw material that is used for a food product adheres to the catalyst, the intended reactivity may not be obtained, or an unintended reaction may progress. For example, in an apparatus that is used in a manufacturing method in which a photocatalyst is used for the purpose of sterilization, when an organic solid is formed on the catalyst, adequate sterilization characteristics are no longer obtained. Even in a food processing apparatus using a photocatalyst, when a state in which an adhering substance exists on a catalyst at the time of introducing a reactant before the start of a reaction is caused to exist, an unintended reaction progresses throughout a reaction process, and thus the expected reaction results may not be obtained. That is, the method using the photocatalyst to reform the raw material for the food product, has room for improving the processability of the food raw material.

One aspect of the present disclosure has been made in consideration of such a circumstance, and provides a food processing apparatus newly using a photocatalyst that reforms a raw material for a food product, and a method for operating the food processing apparatus.

A method for operating a food processing apparatus according to one aspect of the present disclosure is a method for operating a food processing apparatus. The food processing apparatus includes a reaction vessel that has a space that accumulates a liquid reactant used for a food product; a catalytic reactor that includes a reaction tube and a light source; and an introducing tube for introducing the reactant into the reaction vessel. The reaction tube has an outer surface where a photocatalyst is provided. The reaction tube transmits light. The light source generates heat at a time of light emission in which the light source emits light from an inner side of the reaction tube. The method for operating the food processing apparatus includes introducing the reactant into the reaction vessel from the introducing tube. In the introducing, the reactant is introduced up to a position at which a liquid surface of the reactant is positioned higher than an opening portion of the introducing tube.

According to this, in the introducing of the reactant, the reactant is introduced up to the position at which the liquid surface of the reactant accumulated in the space of the reaction vessel is positioned higher than the position of the opening portion of the introducing tube. Therefore, it is possible to reduce a period in which a reactant is introduced from a position situated away from the liquid surface of the reactant accumulated in the reaction vessel, and to reduce the amount of liquid splashing occurring as a result of contact with the reactant that has been already introduced into the reaction vessel. Therefore, foaming that occurs at the liquid surface of the reactant due to a reactant that has been introduced into the reaction vessel can be reduced, and adhesion of the reactant to a surface of the catalytic reactor at the position that is higher than the position of the liquid surface of the reactant can be reduced. Consequently, in a process in the food processing apparatus after introducing the reactant, in particular, in the food processing apparatus including a light source that generates heat at the time of light emission in which the light source emits light from an inner side of the reaction tube, it is possible to reduce the effects of the heat of the light source on alteration reaction of organic matter of a raw material. Thus, it is possible to stably operate the food processing apparatus, and to effectively reform the raw material that is used for a food product.

The reactant may contain a liquid and water, the liquid containing a raw material, and, in the introducing of the reactant, the liquid is introduced after introducing the water into the reaction vessel from the introducing tube.

According to this, by previously introducing the water that is unlikely to foam into the reaction vessel and increasing the height of the liquid surface, even if a reactant that is introduced from the opening portion of the introducing tube collides with the liquid surface, it is possible to reduce the height up to the liquid surface. Therefore, it is possible to reduce the energy of the collision of the introduced reactant with the liquid surface, and to reduce occurrence of foaming.

In the introducing of the reactant, the liquid may be introduced after introducing the water from the introducing tube up to a position at which a liquid surface of the water is positioned higher than the opening portion of the introducing tube.

As described above, since the liquid reactant that is likely to foam is introduced to the water previously accumulated in the reaction vessel, an effect of diluting the liquid reactant can be obtained. Since the liquid reactant is introduced to the water previously accumulated in the reaction vessel, it is possible to introduce the liquid reactant into the water from the opening portion of the introducing tube. Therefore, it is possible to suppress occurrence of foaming when the reactant is introduced into the reaction vessel.

A food processing apparatus according to one aspect of the present disclosure includes a reaction vessel that has a space that accumulates a liquid reactant used for a food product; a catalytic reactor that includes a reaction tube and a light source, the reaction tube having an outer surface where a photocatalyst is provided and transmitting light, the light source generating heat at a time of light emission in which the light source emits light from an inner side of the reaction tube; and an introducing tube for introducing the reactant into the reaction vessel, wherein an opening portion of the introducing tube is provided at a position lower than a position of a lower end of the light source.

According to this, it is possible to reduce the height at which the opening portion of the introducing tube is disposed from a bottom portion of the reaction vessel. Therefore, foaming that occurs at the liquid surface of the reactant due to a reactant that has been introduced into the reaction vessel can be reduced, and adhesion of the reactant to a surface of the catalytic reactor at the position that is higher than the position of the liquid surface of the reactant can be reduced. Consequently, in a process in the food processing apparatus after introducing the reactant, in particular, in the food processing apparatus including a light source that generates heat at a time of light emission in which the light source emits light from an inner side of the reaction tube, it is possible to reduce the effects of the heat of the light source on alteration reaction of organic matter of a raw material. Thus, it is possible to stably operate the food processing apparatus, and to effectively reform the raw material that is used for a food product.

The opening portion may be provided at a position lower than a lower end of a portion where the photocatalyst is provided of the catalytic reactor.

Therefore, it is possible to dispose the opening portion of the introducing tube at a position that is closer to the bottom portion of the reaction vessel.

The opening portion may be provided at a position lower than a position of a bottom portion of the catalytic reactor.

Therefore, it is possible to dispose the opening portion of the introducing tube at a position that is closer to the bottom portion of the reaction vessel.

A food processing apparatus according to another aspect of the present disclosure includes a reaction vessel that has a space that accumulates a liquid reactant used for a food product; a catalytic reactor that includes a reaction tube and a light source, the reaction tube having an outer surface where a photocatalyst is provided and transmitting light, the light source generating heat at a time of light emission in which the light source emits light from an inner side of the reaction tube; and an introducing tube for introducing the reactant into the reaction vessel, wherein the reaction vessel has a mark that is provided at a position at a predetermined height from a bottom surface of the reaction vessel, and wherein an opening portion is provided at a position lower than the position of the mark.

Therefore, in the introduction step, for example, while the reactant is being visually introduced from the introducing tube up to the height of the mark, the liquid surface of the reactant accumulated in the reaction vessel is raised to a position above the opening portion of the introducing tube. Consequently, it is possible to reduce a period in which a reactant is introduced from a position situated away from the liquid surface of the reactant accumulated in the reaction vessel, and to reduce the amount of liquid splashing occurring as a result of contact with the reactant that has been already introduced into the reaction vessel. Therefore, foaming that occurs at the liquid surface of the reactant due to a reactant that has been introduced into the reaction vessel can be reduced, and adhesion of the reactant to a surface of the catalytic reactor at the position that is higher than the position of the liquid surface of the reactant can be reduced. Consequently, in a process in the food processing apparatus after introducing the reactant, in particular, in the food processing apparatus including a light source that generates heat at the time of light emission in which the light source emits light from an inner side of the reaction tube, it is possible to reduce the effects of the heat of the light source on alteration reaction of organic matter of a raw material. Thus, it is possible to stably operate the food processing apparatus, and to effectively reform the raw material that is used for a food product.

A food processing apparatus according to another aspect of the present disclosure includes a reaction vessel that has a space that accumulates a liquid reactant used for a food product; a catalytic reactor that includes a reaction tube and a light source, the reaction tube having an outer surface where a photocatalyst is provided and transmitting light, the light source generating heat at a time of light emission in which the light source emits light from an inner side of the reaction tube; an introducing tube for introducing the reactant into the reaction vessel; and a liquid detector that is disposed inside the space and that detects presence or absence of a liquid, wherein an opening portion is provided at a position lower than a position of the liquid detector.

Consequently, it is possible to reduce a period in which a reactant is introduced from a position situated away from the liquid surface of the reactant accumulated in the reaction vessel, and to reduce the amount of liquid splashing occurring as a result of contact with the reactant that has been already introduced into the reaction vessel. Therefore, foaming that occurs at the liquid surface of the reactant due to a reactant that has been introduced into the reaction vessel can be reduced, and adhesion of the reactant to a surface of the catalytic reactor at the position that is higher than the position of the liquid surface of the reactant can be reduced. Consequently, in a process in the food processing apparatus after introducing the reactant, in particular, in the food processing apparatus including a light source that generates heat at the time of light emission in which the light source emits light from an inner side of the reaction tube, it is possible to reduce the effects of the heat of the light source on alteration reaction of organic matter of a raw material. Thus, it is possible to stably operate the food processing apparatus, and to effectively reform the raw material that is used for a food product.

The food processing apparatus may further include a stirrer that includes a stirring body that stirs the reactant inside the reaction vessel by rotating; and stirring plates that protrude toward an inner side of the reaction vessel from an inner wall surface of the reaction vessel and that are disposed along a rotary shaft of the stirrer, wherein the food processing apparatus may comprise the catalytic reactor that is one of catalytic reactors, wherein the catalytic reactors may be disposed around the rotary shaft of the stirring body to be spaced from each other, and wherein the introducing tube may be provided along a wall surface of one of the stirring plates and along the inner wall surface of the reaction vessel.

Therefore, it is possible to rectify the flow of the reactant to a vertical direction by the stirring plates, and to cause the reactant to flow along the introducing tube disposed so as to be oriented with its longitudinal direction being the same as that of each stirring plate 21. Therefore, it is possible to reduce the effects of the introducing tube on the stirring state.

When viewed from an upper surface of the reaction vessel, with respect to a direction of rotation of the stirrer, the introducing tube may be provided along a wall surface of the stirring plate, the wall surface being on a front side in the direction of rotation.

Since the reactant flows in the direction of rotation of the stirrer, a rear surface of the stirring plate in the direction of rotation becomes an upstream side in a direction of flow of the reactant, and the amount of reactant that contacts the wall surface of the stirring plate on the rear side in the direction of rotation is less than the amount of reactant that contacts the wall surface of the stirring plate on the front side in the direction of rotation. Since the introducing tube is disposed at the wall surface of the stirring plate on the front side in the direction of rotation (that is, a downstream side in the direction of flow of the reactant), it is possible to reduce the effects of the introducing tube on the stirring.

Hereinafter, specific examples of embodiments will be described with reference to the accompanying drawings.

Each of the specific examples described below is one example of the aforementioned aspects. Accordingly, the shapes, materials, components, arrangement positions and connection forms of the components, and the like presented below are not intended to limit the aforementioned aspects unless those are described in the claims. Among the following components, components that are not described in the independent claims defining the most generic concept of the present aspects are described as optional components. Description of components denoted by the same reference signs in the drawings may be omitted. In the drawings, each component is schematically illustrated for ease of understanding, and shapes, dimensional ratios, and the like thereof may not be accurately illustrated.

### First Embodiment

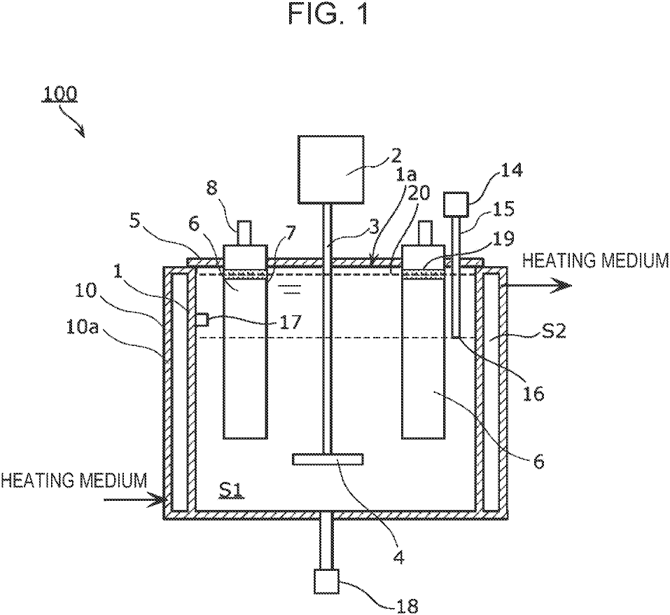

A structure of a food processing apparatus 100 will be described with reference to FIG. 1. FIG. 1 illustrates one example of the food processing apparatus 100 according to a first embodiment.

As illustrated in FIG. 1, the food processing apparatus 100 includes a reaction vessel 1, a stirrer 2, catalytic reactors 6, a temperature adjuster 10, a temperature detector 11, a controller 13, a raw material supplier 14, a liquid detector 17, and a discharger 18.

The reaction vessel 1 has a first space S1 for accumulating a liquid reactant that is to be used for a food product. A reactant or a processed resulting product processed from the reactant is included in the food product. The reaction vessel 1 is, for example, a container having a cylindrical shape with a bottom. The reaction vessel 1 may be any container having a tubular shape with a bottom and having the first space S1 for accumulating the liquid reactant, and the shape thereof need not be a cylindrical shape. The reaction vessel 1 has a lid 5 that covers an opening at an upper portion of the reaction vessel 1. The lid 5 is a disc-shaped member, and has through holes through which a rotary shaft 3 of a stirring body 4, the catalyst reactors 6, and the temperature detector 11 extend.

The stirrer 2 includes the stirring body 4 that rotates to thereby stir the reactant in the reaction vessel 1. The stirrer 2 is disposed such that the rotary shaft 3 of the stirrer 2 corresponds to the center axis of the cylinder of the reaction vessel 1. The stirrer 2 includes a motor (not illustrated) that rotates the rotary shaft 3.

Here, a specific example of the stirring body 4 will be described.

The stirring body 4 may be realized by, for example, an inclined paddle blade. The stirring body 4 may be realized by any one of a propeller blade, a disk turbine blade, and a centrifugal stirring body to achieve optimal processing conditions in consideration of operation processing conditions such as the viscosity of the reactant and the power consumption of the stirrer 2. When stirring bodies 4 are used in the food processing apparatus 100, it is sufficient for each stirring body 4 to include at least one of the inclined paddle blade, the propeller blade, the disk turbine blade, or the centrifugal stirring body.

The food processing apparatus 100 includes more than one catalytic reactor 6. The catalytic reactors 6 (six catalytic reactors 6 in the present embodiment) are disposed around the rotary shaft 3 of the stirring body 4 in a state of being spaced from each other when viewed in an axial direction of the rotary shaft 3 of the stirring body 4. With the catalytic reactors 6 extending through the lid 5, the catalytic reactors 6 are fixed to the lid 5. An outer side of the six catalytic reactors 6 is surrounded by an inner wall surface of the reaction vessel 1. That is, the catalytic reactors 6 are disposed in the first space S1 in the reaction vessel 1. Consequently, when the reactant inside the reaction vessel 1 is stirred by the stirrer 2, the stirred reactant can move among the catalytic reactors 6.

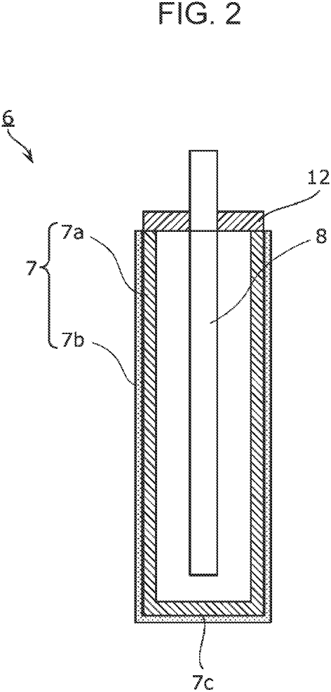

Here, details of the structure of the catalytic reactors 6 will be described with reference to FIG. 2. FIG. 2 illustrates one example of the structure of the catalytic reactors 6 according to the first embodiment.

As illustrated in FIG. 2, each of the catalytic reactors 6 includes a reaction tube 7 and a light source 8. Each catalyst reactor 6 may also include a sealing portion 12 that seals a gap between the light source 8 and an opening portion 7d of the reaction tube 7 having a bottom surface 7c at one end and the opening portion 7d at the opposite end (other end). Dry gas may be sealed inside the reaction tubes 7.

The reaction tube 7 has an outer surface where a photocatalyst is provided, and the bottom surface 7c having one end sealed, and transmits light. Specifically, the reaction tube 7 includes a glass substrate 7a having a cylindrical shape with a bottom, and a photocatalyst thin film 7b provided on an outer surface of the glass substrate 7a. The glass substrate 7a is disposed such that a cylinder axis direction of the cylindrical shape of the glass substrate 7a extends along the rotary shaft 3 of the stirring body 4.

The photocatalyst thin film 7b provided on the outer surface of the glass substrate 7a is formed by, for example, a general sol-gel method. Specifically, the photocatalyst thin film 7b is constituted by TiO₂. A sol-gel solution used in the method for forming the photocatalyst thin film 7b is applied to the outer surface of the glass substrate 7a, and the glass substrate 7a with the sol-gel solution applied thereto is rotated by using a rotary machine. Consequently, the sol-gel solution is uniformly applied to the entirety of the outer surface of the glass substrate 7a. After the sol-gel solution is dried, the glass substrate 7a on which the sol-gel solution is applied is dried in an electric furnace and then is heated at a high temperature of higher than or equal to 500° C., as a result of which the photocatalyst thin film 7b is heat-treated on the outer surface of the glass substrate 7a.

The light source 8 irradiates the photocatalyst with light from an inner side of the reaction tube 7. The light source 8 generates heat at the time of light emission. The light source 8 is inserted into the inside of the glass substrate 7a from an open portion of the glass substrate 7a opposite to the bottom surface 7c. Specifically, the light source 8 includes a light source having a central wavelength of approximately 260 nm to 400 nm to effectively generate excitons in the photocatalyst. The light source 8 includes, for example, a fluorescent lamp in which a wavelength in an ultraviolet wavelength region of 315 nm to 400 nm (UV-A) is a central wavelength. Therefore, it is possible to effectively accelerate the reaction of a reactant by the photocatalyst.

The light source 8 may be disposed to face the thin film 7b provided on the outer surface of the reaction tube 7 to effectively irradiate the thin film 7b provided on the outer surface of the glass substrate 7a with light. The light source 8 may include, for example, a high-pressure mercury lamp or an LED (Light Emitting Diode) that emits ultraviolet rays. Since an LED has a high luminance efficiency and generates a small amount of heat, compared with a light source that generates a large amount of heat, it is possible to reduce the strength of convection that is generated inside the reaction tube 7, and to suppress outside air from being taken into the reaction tube 7. Similarly, it is preferable to use a fluorescent lamp that generates a small amount of heat.

The temperature adjuster 10 adjusts the temperature of a reactant in the reaction vessel 1. The temperature adjuster 10 is disposed to surround the outer side of the catalytic reactors 6. Specifically, the temperature adjuster 10 has an outer wall 10a that surrounds the reaction vessel 1, and a heating medium that flows in a second space S2 between the reaction vessel 1 and the outer wall 10a.

The temperature adjuster 10 adjusts the temperature of a reactant by operating on the basis of the temperature detected by the temperature detector 11. Specifically, when a reactant having a temperature higher than a first temperature is to be cooled to the first temperature, the temperature adjuster 10 causes refrigerant, serving as the heating medium, having a temperature lower than or equal to the first temperature to flow in the second space S2. Consequently, the temperature adjuster 10 cools the reactant by causing the refrigerant and the reactant to exchange heat with each other with the reaction vessel 1 interposed between the refrigerant and the reactant. After the temperature of the refrigerant is increased as a result of heat exchange between the refrigerant and the reactant, the refrigerant may, for example, be cooled to a temperature less than or equal to the first temperature by a heat exchanger (not illustrated) disposed outside the second space S2, and then returned to the second space S2 through a pipe (not illustrated). The refrigerant may be circulated between the second space S2 and the aforementioned heat exchanger by, for example, a circulation pump (not illustrated). In this case, the temperature adjuster 10 may start cooling the reactant by starting the operation of the circulation pump.

The temperature adjuster 10 may heat a reactant having a temperature lower than a second temperature to the second temperature. In this case, the temperature adjuster 10 causes a heating medium having a temperature higher than or equal to the second temperature to flow in the second space S2. Consequently, the temperature adjuster 10 heats the reactant by causing the heating medium and the reactant to exchange heat with each other with the reaction vessel 1 interposed between the heating medium and the reactant. After the temperature of the refrigerant is decreased as a result of heat exchange between the refrigerant and the reactant, the refrigerant may, for example, be heated to a temperature greater than or equal to the second temperature by a heat exchanger disposed outside the second space S2, and then returned to the second space S2 through a pipe.

The temperature detector 11 is disposed inside the reaction vessel 1 and detects the temperature of a reactant. The temperature detector 11 is constituted by, for example, a thermistor, a thermocouple, or the like. The temperature detector 11 extends through the lid 5 and, for example, is fixed to the lid 5.

The raw material supplier 14 is a device that supplies a liquid reactant constituted by water and a raw material, or water to the reaction vessel 1. An introducing tube 15 that is disposed inside the reaction vessel 1 is connected to the raw material supplier 14, and the reactant or the water is introduced into the reaction vessel 1 through the introducing tube 15.

The introducing tube 15 introduces the reactant or the water supplied from the raw material supplier 14 into the reaction vessel 1. An opening portion 16 of the introducing tube 15 is provided at a position lower than the position of an opening surface 1a of the reaction vessel 1 inside the first space S1 of the reaction vessel 1. The opening portion 16 of the introducing tube 15 is an outlet of the reactant or the water supplied to the introducing tube 15 by the raw material supplier 14, and is an opening portion from where the reactant or the water is discharged.

The liquid detector 17 may be disposed inside the first space S1 of the reaction vessel 1, for example, at an inner wall surface of the reaction vessel 1 so as to be positioned at a predetermined height from a bottom portion of the reaction vessel 1. The liquid detector 17 may be disposed at a position higher than the position of the opening portion 16 of the introducing tube 15. In other words, the opening portion of the introducing tube 15 may be provided at a position lower than the position of the liquid detector 17. The liquid detector 17 is, for example, a sensor that detects presence or absence of a liquid by contacting the liquid. The predetermined height is, for example, a height that is lower than the height of the liquid surface of a reactant that has been introduced into the reaction vessel 1 by an amount to be used in one reaction in the food processing apparatus 100. The height of the liquid surface of the reactant that has been introduced into the reaction vessel 1 by the amount to be used in one reaction is a height that is lower than the position of the opening surface 1a of the reaction vessel 1. That is, the height of the liquid surface of the reactant that is introduced into the reaction vessel 1 in one reaction may be set between the predetermined height and the position of the opening surface 1a of the reaction vessel 1.

The discharger 18 is disposed at the bottom portion of the reaction vessel 1, and discharges the reactant or the water accumulated in the reaction vessel 1. The discharger 18 is connected to a discharge opening (not illustrated) that extends through the bottom portion of the reaction vessel 1, and may be constituted by a valve, such as an electromagnetic valve or an electric valve, that switches between a state in which the reactant or the water accumulated in the reaction vessel 1 is discharged from the discharge opening (open state) and a state in which the reactant or the water is not discharged (closed state).

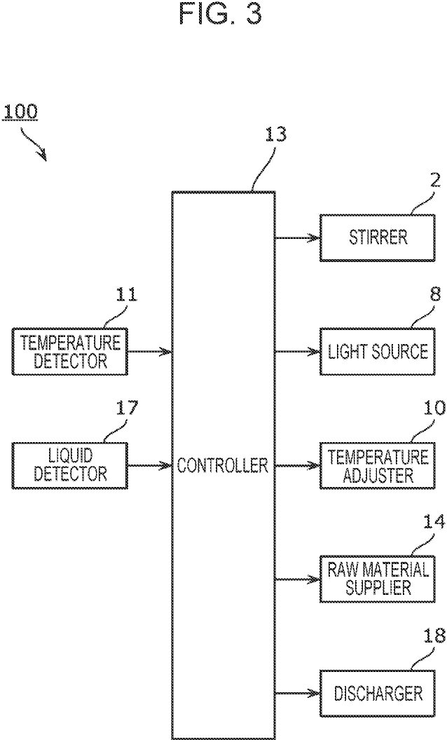

Next, the controller 13 of the food processing apparatus 100 will be described with reference to FIG. 3. FIG. 3 is a block diagram of the food processing apparatus 100 according to the first embodiment.

The controller 13 controls the operation of the food processing apparatus 100. The controller 13 obtains a detection result of at least one of the temperature detector 11 or the liquid detector 17, and controls at least one of the stirrer 2, the light source 8, the temperature adjuster 10, the raw material supplier 14, or the discharger 18 in accordance with the obtained detection result. The controller 13 may be realized by, for example, a processor and a memory that stores a program that is executed by the processor. The controller 13 may be realized by, for example, a dedicated circuit.

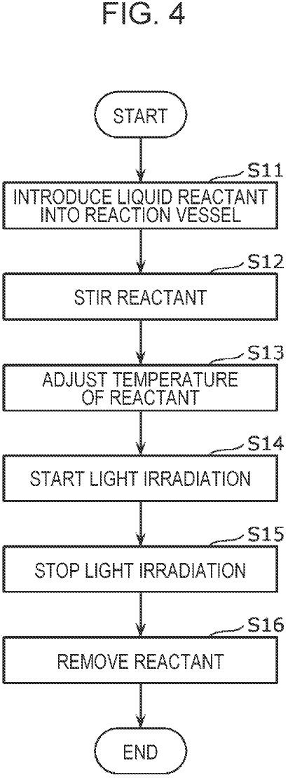

Next, the operation of the food processing apparatus 100 will be described with FIG. 4. FIG. 4 is a flowchart showing one example of a method for operating the food processing apparatus 100 according to the first embodiment.

First, the controller 13 causes a liquid reactant to be introduced into the reaction vessel 1 from the raw material supplier 14 (S11: introduction step). The controller 13 may cause the reactant to be introduced up to a position at which a liquid surface of a reactant accumulated in the first space S1 of the reaction vessel 1 is higher than the position of the opening portion 16 of the introducing tube 15.

Next, the controller 13 operates the stirrer 2 to stir the reactant (S12: stirring step). In the stirring step, by stirring the reactant, it is possible to increase contactability between the reactant and the catalytic reactors 6 and to increase reforming reactivity.

The controller 13 causes the light source 8 of each catalytic reactor 6 to emit light, and causes light irradiation with respect to the photocatalyst thin film 7b provided on the outer side to be started from the inside of the reaction tube 7 (S13: light irradiation step). By irradiating the photocatalyst thin film 7b with light, organic components of a raw material come into contact with a photocatalyst thin film layer 9 of each catalytic reactor 6 and reacts with excitons generated in the photocatalyst thin film layer 9 as a result of the irradiation with light from the light source 8, thereby causing the reaction for reforming the raw material to progress.

The controller 13 causes a cooling medium to be supplied to the temperature adjuster 10 (S14: temperature adjustment step). The controller 13 causes the temperature detector 11 to detect the temperature of the reactant and causes the temperature and the supply amount of the cooling medium to be adjusted by using, for example, a constant-temperature water circulation apparatus (not illustrated) such that the temperature of the reactant becomes a preset temperature. The light source 8, whether it is a high-pressure mercury lamp, an LED that emits ultraviolet rays, or a fluorescent lamp, generates heat at the time of light emission, and thermally affects the catalytic reactors 6 and the reactant.

For example, when the reaction of the reactant in the food processing apparatus 100 is fermentation of beer yeast, the beer yeast may be fermented at a low temperature (for example, approximately 5° C.). In this case, the temperature that is preset as a target at the temperature adjuster 10 is 5° C. In the food processing apparatus 100, a purpose is to bring the photocatalyst irradiated with light and the reactant serving as a raw material for a food product into contact with each other and to thereby reform the reactant by the photocatalyst. For example, in a case where a raw material of beer is reformed, the period of time of fermentation can be shortened by previously decomposing the sugars in wort.

The stirring step of Step S12, the light irradiation step of Step S13, and the temperature adjustment step of Step S14 need not be performed in this order, and thus these steps may be performed in a different order or may be started at the same time. The stirring step of Step S12, the light irradiation step of Step S13, and the temperature adjustment step of Step S14 may be performed at the same time in the same period.

When a time that has been preset from the start of the light irradiation by the light source 8 elapses, the controller 13 stops the stirring step, the light irradiation step, and the temperature adjustment step (S15). Thus, it is possible to efficiently reform the reactant as a result of irradiating the photocatalyst with light by continuing the stirring step, the light irradiation step, and the temperature adjustment step for only the preset time.

After the processing of Step S15 ends, the controller 13 drives the discharger 18 to thereby take out the reactant from the reaction vessel 1 (S16) and ends the series of food processing operations performed by the reforming reaction.

### Effects Etc.

In this food processing process, when a reactant adheres to the outer surface of each catalytic reactor 6, the generation of heat by the light source at the time of light irradiation dries the reactant adhered to the outer surface and forms a porous reactant film, as a result of which the catalytic reaction is thereby adversely affected. In the food processing process after a reactant has been introduced, as illustrated in FIG. 1, each catalytic reactor 6 that contacts the reactant is disposed below a reactant liquid surface 20, and the probability of the reactant being brought into a dried state and a reactant film being formed is low. However, in the introduction step, when a liquid reactant is introduced into the reaction vessel 1, liquid splashing occurs as a result of the introduced reactant coming into contact with the bottom portion of the reaction vessel 1 or the introduced reactant coming into contact with a reactant that has already been introduced into the reaction vessel 1, as a result of which the reactant may adhere to the surface of each catalytic reactor 6 due to the liquid splashing. In particular, as a result of adhesion of the reactant to the vicinity of interfaces 19 between the reactant liquid surface 20 and the corresponding catalytic reactors 6, the reactant adheres to the surface of each catalytic reactor 6 at a position higher than the position of the reactant liquid surface 20. In the food processing process after the introduction step, the reactant adhered to the position higher than the position of the reactant liquid surface 20 is affected by the heat from the light source that generates heat, and is dried, as a result of which a reactant film tends to be formed. When the reactant film is formed in the vicinity of the interfaces 19 and the liquid reactant in the reaction vessel 1 comes into contact with this reactor film, the reactant film sucks up the reactant due to a capillary action, and, further, a state of drying by the heat source is repeated to cause the reactant film to grow. Further, in the reactant film, the action of a photocatalyst and the heat of the light source cause an alteration reaction of organic matter of a raw material to occur. When the reactant film and the liquid reactant in the reaction vessel 1 are in contact with each other, part of a component produced by the alteration reaction may be dissolved in a reaction liquid inside the reaction vessel 1, and causes a reduction in the quality of a final product. At the time of introduction of the reactant in the introduction step, when the reactant film is formed in the vicinity of the interfaces 19, the effects of the reactant film last for a long time throughout the subsequent steps, as a result of which the growth of the reactant film and the progress of the alteration reaction are further accelerated.

Thus, in the food processing apparatus 100 of the first embodiment, the opening portion 16 of the introducing tube 15 for introducing a reactant into the reaction vessel 1 is provided at a position lower than the position of the opening surface 1a of the reaction vessel 1 inside the first space S1 of the reaction vessel 1. According to this, it is possible to reduce the height at which the opening portion 16 of the introducing tube 15 is disposed from the bottom portion of the reaction vessel 1. Therefore, foaming that occurs at the liquid surface of the reactant due to a reactant that has been introduced into the reaction vessel 1 can be reduced, and adhesion of the reactant to the surface of each catalytic reactor 6 at the position that is higher than the position of the reactant liquid surface 20 can be reduced. Consequently, in the food processing process in the food processing apparatus 100 after the introduction step, in particular, in the food processing apparatus including a light source that generates heat at the time of light emission in which the light source emits light from an inner side of the reaction tube, it is possible to reduce the effects of the heat of the light source on alteration reaction of organic matter of a raw material. Thus, it is possible to stably operate the food processing apparatus 100, and to effectively reform the raw material that is used for a food product.

In the food processing apparatus 100 of the first embodiment, in the introduction step, the reactant is introduced up to a position at which the liquid surface of the reactant accumulated in the first space S1 of the reaction vessel 1 is positioned higher than the position of the opening portion 16 of the introducing tube 15. Therefore, it is possible to reduce a period in which a reactant is introduced from a position situated away from the liquid surface of the reactant accumulated in the reaction vessel 1, and to reduce the amount of liquid splashing occurring as a result of contact with the reactant that has been already introduced into the reaction vessel 1. Therefore, foaming that occurs due to a reactant that has been introduced into the reaction vessel 1 can be reduced, and, in the food processing process in the food processing apparatus 100 after the introduction step, it is possible to reduce the effects of alteration reaction of organic matter of a raw material. Thus, it is possible to stably operate the food processing apparatus, and to effectively reform the raw material that is used for a food product.

### Modification 1

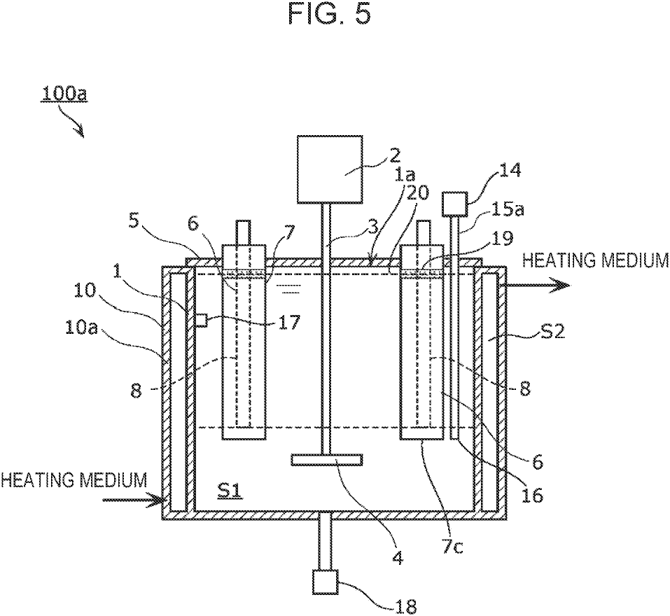

In the food processing apparatus 100 according to the first embodiment mentioned above, although the opening portion 16 of the introducing tube 15 is provided at a position lower than the position of the liquid detector 17, the opening portion 16 is not limited thereto. For example, as in a food processing apparatus 100a illustrated in FIG. 5, an opening portion 16 of an introducing tube 15a may be provided at a position lower than a lower end of each light source 8.

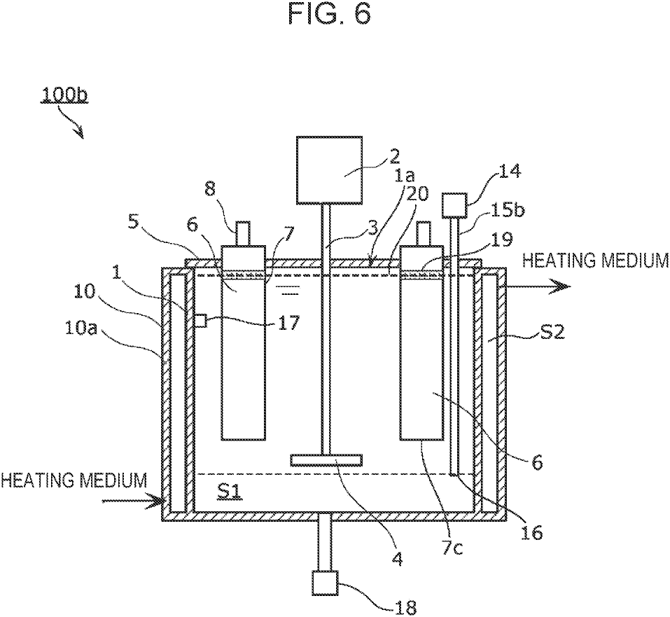

For example, as in a food processing apparatus 100b illustrated in FIG. 6, an opening portion 16 of an introducing tube 15b may be provided at a position lower than a lower end of a portion where a photocatalyst is provided of each catalytic reactor 6.

The opening portion 16 of the introducing tube may be provided at a position lower than the bottom portion of each catalytic reactor 6, that is, a position lower than the position of the bottom surface 7c of each reaction tube 7. Here, since the photocatalyst thin film 7b of each catalytic reactor 6 is also formed on the bottom surface 7c of a corresponding one of the reaction tube 7, in the example illustrated in FIG. 5, the lower ends of the portions where the photocatalysts are provided and the bottom portions (the bottom surfaces 7c) of the catalytic reactors 6 are the same.

In the case where the lower ends of the portions where the photocatalysts are provided and the bottom portions (bottom surfaces 7c) of the catalytic reactors 6 differ from each other, and the lower ends of the portions where the photocatalysts are provided are situated above the bottom portions (bottom surfaces 7c) of the catalytic reactors 6, if it is sufficient for the opening portion 16 of the introducing tube to be provided at a position lower than the lower ends of the portions where the photocatalysts are provided of the catalytic reactors 6, the opening portion 16 may be provided between the lower ends of the portions where the photocatalysts are provided and the bottom portions (bottom surfaces 7c) of the catalytic reactors 6.

As shown by these examples, when the opening portion 16 of the introducing tube is provided at a position near the bottom portion of the reaction vessel 1, it is possible to reduce the probability of liquid splashing of a reactant toward the vicinity of the interfaces 19 between the reactant and the corresponding catalytic reactors 6.

### Modification 2

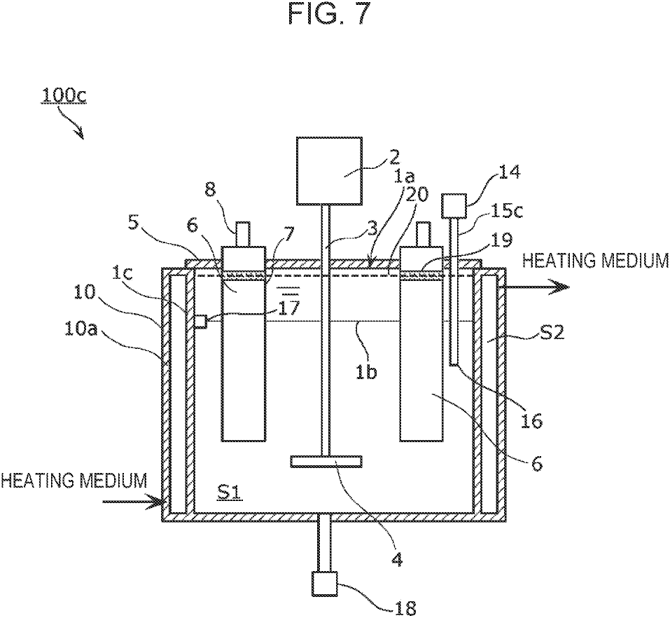

As illustrated in FIG. 7, a reaction vessel 1c of a food processing apparatus 100c according to Modification 2 may have a mark 1b that is provided at a position at a predetermined height from a bottom surface of the reaction vessel 1c. An opening portion 16 of an introducing tube 15c may be provided at a position lower than the position of the mark 1b. When the mark 1b is provided, the food processing apparatus 100c need not include a liquid detector 17. The predetermined height at which the mark 1b is provided may be the same as, for example, the predetermined height at which the liquid detector 17 of the food processing apparatus 100 of the first embodiment is provided.

Thus, in the introduction step, for example, while a person is visually introducing a reactant from the introducing tube 15c up to the height of the mark 1b, the liquid surface of a reactant accumulated in the reaction vessel 1c rises above the opening portion 16 of the introducing tube 15. Therefore, it is possible to reduce a period in which a reactant is introduced from a position situated away from the liquid surface of the reactant accumulated in the reaction vessel 1c, and to reduce the amount of liquid splashing occurring as a result of contact with the reactant that has already been introduced into the reaction vessel 1c. Therefore, foaming that occurs at the liquid surface of the reactant due to a reactant that has been introduced into the reaction vessel 1c can be reduced, and adhesion of the reactant to a surface of each catalytic reactor 6 at the position that is higher than the position of the reactant liquid surface 20 can be reduced. Consequently, in the food processing process in the food processing apparatus 100c after the introduction step, in particular, in the food processing apparatus including a light source that generates heat at the time of light emission in which the light source emits light from an inner side of the reaction tube, it is possible to reduce the effects of the heat of the light source on alteration reaction of organic matter of a raw material. Thus, it is possible to stably operate the food processing apparatus, and to effectively reform the raw material that is used for a food product.

### Modification 3

When a reactant is introduced into the reaction vessel 1, the reactant may foam due to the physical properties of a liquid reactant. When the reactant is introduced and the liquid surface of a reactant accumulated in the reaction vessel 1 and the reactant being introduced come into contact with each other, surrounding gas gets sucked and foam is formed, as a result of which foaming occurs. When the foaming occurs at the time of the introduction of the reactant, the height of the liquid surface of the foaming reactant resulting from the foaming becomes higher than the originally assumed height of the liquid surface of a reactant not containing foam by an amount corresponding to the foaming amount, as a result of which the probability of adhesion of the reactant that has become foam to an upper surface from the vicinity of the interfaces 19 between the reactant and the corresponding catalytic reactors 6 is increased. In the food processing process, even after defoaming has progressed and the height of the liquid surface has become the originally assumed height of the liquid surface of a reactant not containing foam, the reactant that has become foam up to this time adheres to the catalytic reactors 6, and thus the adhered reactant thereafter dries and forms a porous reactant film in the vicinity of the interfaces 19.

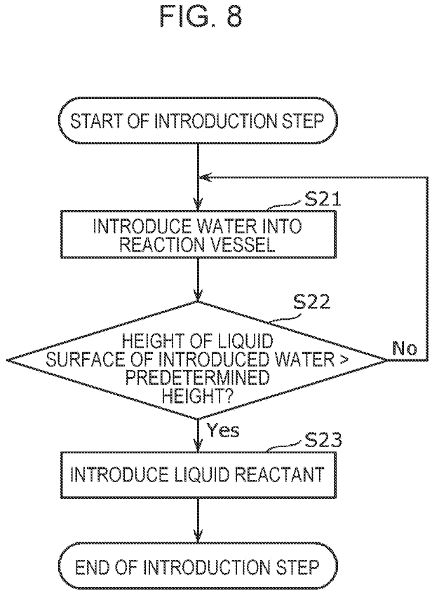

Thus, in the food processing apparatus 100 according to Modification 3, an introduction step illustrated in FIG. 8 may be performed. FIG. 8 is a flowchart of an introduction step according to Modification 3 of the first embodiment.

Specifically, in the food processing apparatus 100, in the introduction step of Step S11, the controller 13 causes water for constituting a liquid reactant to be introduced into the reaction vessel 1 from the raw material supplier 14 (S21).

Next, the controller 13 determines whether or not the height of the liquid surface of the water that has been introduced into the reaction vessel 1 is higher than a predetermined height (S22). Specifically, when the liquid detector 17 detects a liquid, the controller 13 determines that the height of the liquid surface of the water that has been introduced into the reaction vessel 1 is higher than the predetermined height, whereas, when the liquid detector 17 does not detect the liquid, the controller 13 determines that the height of the liquid surface of the water that has been introduced into the reaction vessel 1 is less than or equal to the predetermined height. Since the opening portion 16 of the introducing tube 15 is provided at a position lower than the predetermined height, when the controller 13 determines that the height of the liquid surface of the water is higher than the predetermined height, the controller 13 can determine that the height of the liquid surface of the water is higher than the position of the opening portion 16.

When the controller 13 determines that the height of the liquid surface of the water that has been introduced into the reaction vessel 1 is higher than the predetermined height (Yes in S22), the introduction of water is stopped and a liquid containing a raw material for constituting a reactant is introduced (S23). On the other hand, when the controller 13 determines that the height of the liquid surface of the water that has been introduced into the reaction vessel 1 is lower than or equal to the predetermined height (No in S22), the process returns to Step S21. That is, the controller 13 causes water to be introduced into the reaction vessel 1 until the water level of the water becomes higher than the predetermined height.

Thus, since the liquid reactant that is likely to foam is introduced to the water previously accumulated in the reaction vessel 1, an effect of diluting the liquid reactant can be obtained. Since the liquid reactant is introduced to the water previously accumulated in the reaction vessel 1, it is possible to introduce the liquid reactant into the water from the opening portion 16 of the introducing tube 15. Therefore, it is possible to suppress occurrence of foaming when the reactant is introduced into the reaction vessel 1.

That is, by suppressing occurrence of foaming in the introduction step, it is possible to suppress adhesion of the reactant to each catalytic reactor 6 caused by the foaming, to suppress part of a component produced by an alteration reaction of an adhered substance from being dissolved in a reaction liquid inside the reaction vessel 1, and to suppress a reduction in the quality of a final product.

In the example of FIG. 8, although a liquid containing a raw material for constituting a reactant is introduced after water has been introduced into the reaction vessel 1 such that the height of the liquid surface of the water is higher than the position of the opening portion 16 of the introducing tube 15, it is sufficient for the water to be introduced before the liquid containing a raw material for constituting a reactant is introduced, and the water need not be introduced until the water level is higher than the position of the opening portion 16 of the introducing tube 15. This is because, by previously introducing water that is unlikely to foam into the reaction vessel 1 and increasing the height of the liquid surface, even if the reactant that is introduced from the opening portion 16 of the introducing tube 15 collides with the liquid surface, it is possible to reduce the height up to the liquid surface, as a result of which it is possible to reduce the energy of the collision of the introduced reactant with the liquid surface. That is, this makes it possible to reduce occurrence of foaming.

### Modification 4

Although the food processing apparatus 100 according to the first embodiment mentioned above includes catalytic reactors 6, the food processing apparatus 100 may include one catalytic reactor 6.

### Second Embodiment

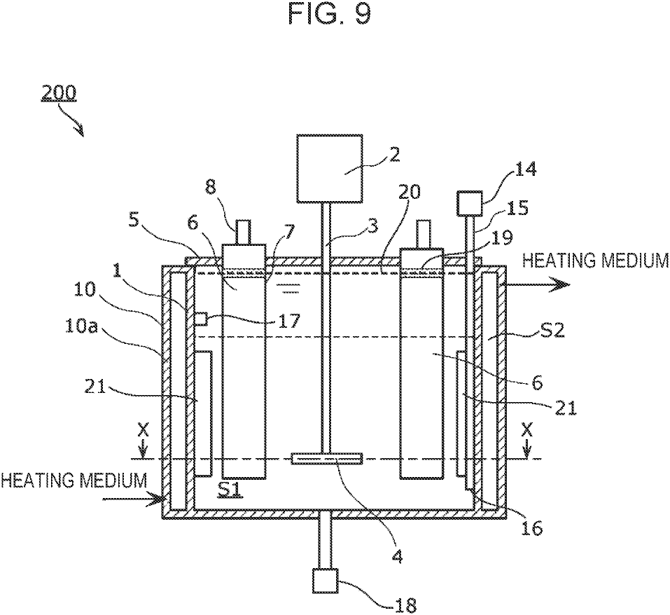

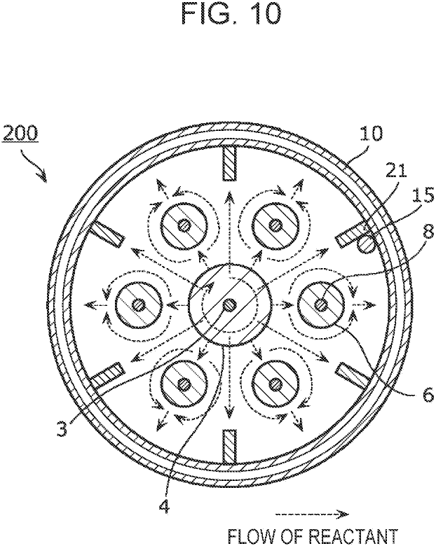

Next, a food processing apparatus 200 of a second embodiment is described. FIG. 9 illustrates one example of the food processing apparatus 200 according to the second embodiment. FIG. 10 is a sectional view along X-X in FIG. 9.

As illustrated in FIGS. 9 and 10, the food processing apparatus 200 of the second embodiment differs from the food processing apparatus 100 of the first embodiment in further including stirring plates 21 that protrude toward an inner side of a reaction vessel 1 from an inner wall surface of the reaction vessel 1, and in an introducing tube 15 being disposed along one of the stirring plates 21. The stirring plates 21 are each, for example, a long plate-shaped member, with its longitudinal direction being along a rotary shaft 3. The introducing tube 15 is disposed along a wall surface of the one stirring plate 21 mentioned above, and along the inner wall surface of the reaction vessel 1.

The food processing apparatus 200 processes a reactant with a photocatalyst by an operation that is the same as the operation of the food processing apparatus 100 of the first embodiment illustrated in FIG. 4.

Since the food processing apparatus 200 according to the second embodiment further includes stirring plates 21, it is possible to improve a stirring state of a reactant to increase the contactability of the reactant with respect to each catalytic reactor 6 and to stabilize the reactivity of the reactant by a photocatalyst.

For example, when the introducing tube 15 is set at a desired position, the introducing tube 15 affects the flowability of a reactant, and a stirring state of the reactant at the reaction vessel 1 changes. Therefore, the introducing tube 15 may be set at a place that is unlikely to affect the stirring. Thus, in the food processing apparatus 200, the introducing tube 15 is set along the wall surface of one stirring plate 21. Since each stirring plate 21 has the function of rectifying the flow of the reactant to a vertical direction, and the reactant flows along the introducing tube 15 disposed so as to be oriented with its longitudinal direction being the same as that of each stirring plate 21, it is possible to reduce the effects of the introducing tube 15 on the stirring. When viewed from an upper surface of the reaction vessel 1, with respect to a direction of rotation of a stirrer 2, the introducing tube 15 may be installed along the wall surface of the stirring plate 21 on a front side in the direction of rotation. Since the reactant flows in the direction of rotation of the stirrer 2, a surface of the stirring plate 21 on a rear side in the direction of rotation mentioned above becomes an upstream side in a direction of flow of the reactant, and the amount of reactant that contacts a wall surface of the stirring plate 21 on the rear side in the direction of rotation is smaller than the amount of reactant that contacts a wall surface of the stirring plate on the front side in the direction of rotation. Since the introducing tube 15 is disposed at the wall surface of the stirring plate 21 on the front side in the direction of rotation (that is, a downstream side in the direction of flow of the reactant), it is possible to reduce the effects of the introducing tube 15 on the stirring.

As described above, the food processing apparatuses 100 and 200 of the present disclosure provide, by using a simple structure and operation method, the effect of making it possible to effectively reform a raw material that is used for a food product by suppressing the effect of adhesion of a reactant to the catalytic reactors 6.

One aspect of the present disclosure can be applied to, for example, a food processing apparatus that uses a photocatalyst that reforms a raw material for a food product, and a method for operating the food processing apparatus.

What is claimed is:

1. A method for operating a food processing apparatus,
wherein the food processing apparatus includes:
a reaction vessel that has a space that accumulates a liquid reactant used for a food product;
a catalytic reactor that includes a reaction tube and a light source; and
an introducing tube for introducing the reactant into the reaction vessel,
wherein the reaction tube has an outer surface where a photocatalyst is provided,
wherein the reaction tube transmits light, and
wherein the light source generates heat at a time of light emission in which the light source emits light from an inner side of the reaction tube, and
wherein the method for operating the food processing apparatus comprises:
introducing the reactant into the reaction vessel from the introducing tube,
wherein, in the introducing, the reactant is introduced up to a position at which a liquid surface of the reactant is positioned higher than an opening portion of the introducing tube.

2. The method for operating the food processing apparatus according to claim 1,
wherein the reactant contains a liquid and water, the liquid containing a raw material, and
wherein, in the introducing of the reactant, the liquid is introduced after introducing the water into the reaction vessel from the introducing tube.

3. The method for operating the food processing apparatus according to claim 2,
wherein, in the introducing of the reactant, the liquid is introduced after introducing the water from the introducing tube up to a position at which a liquid surface of the water is positioned higher than the opening portion of the introducing tube.

4. A food processing apparatus comprising:
a reaction vessel that has a space that accumulates a liquid reactant used for a food product;
a catalytic reactor that includes a reaction tube and a light source, the reaction tube having an outer surface where a photocatalyst is provided and transmitting light, the light source generating heat at a time of light emission in which the light source emits light from an inner side of the reaction tube; and
an introducing tube for introducing the reactant into the reaction vessel,
wherein an opening portion of the introducing tube is provided at a position lower than a position of a lower end of the light source.

5. The food processing apparatus according to claim 4,
wherein the opening portion is provided at a position lower than a lower end of a portion where the photocatalyst is provided of the catalytic reactor.

6. The food processing apparatus according to claim 4,
wherein the opening portion is provided at a position lower than a position of a bottom portion of the catalytic reactor.

7. A food processing apparatus comprising:
a reaction vessel that has a space that accumulates a liquid reactant used for a food product;
a catalytic reactor that includes a reaction tube and a light source, the reaction tube having an outer surface where a photocatalyst is provided and transmitting light, the light source generating heat at a time of light emission in which the light source emits light from an inner side of the reaction tube; and
an introducing tube for introducing the reactant into the reaction vessel,
wherein the reaction vessel has a mark that is provided at a position at a predetermined height from a bottom surface of the reaction vessel, and
wherein an opening portion is provided at a position lower than the position of the mark.

8. A food processing apparatus comprising:
a reaction vessel that has a space that accumulates a liquid reactant used for a food product;
a catalytic reactor that includes a reaction tube and a light source, the reaction tube having an outer surface where a photocatalyst is provided and transmitting light, the light source generating heat at a time of light emission in which the light source emits light from an inner side of the reaction tube;
an introducing tube for introducing the reactant into the reaction vessel; and
a liquid detector that is disposed inside the space and that detects presence or absence of a liquid,
wherein an opening portion is provided at a position lower than a position of the liquid detector.

9. The food processing apparatus according to claim 4, further comprising:
a stirrer that includes a stirring body that stirs the reactant inside the reaction vessel by rotating; and
stirring plates that protrude toward an inner side of the reaction vessel from an inner wall surface of the reaction vessel and that are disposed along a rotary shaft of the stirrer,
wherein the food processing apparatus comprises the catalytic reactor that is one of catalytic reactors,
wherein the catalytic reactors are disposed around the rotary shaft of the stirring body to be spaced from each other, and
wherein the introducing tube is provided along a wall surface of one of the stirring plates and along the inner wall surface of the reaction vessel.

10. The food processing apparatus according to claim 9,
wherein, when viewed from an upper surface of the reaction vessel, with respect to a direction of rotation of the stirrer, the introducing tube is provided along a wall surface of the stirring plate, the wall surface being on a front side in the direction of rotation.
